(19) United States
(12) Patent Application Publication
(10) Pub. No.: US 2017/0122452 A1
(43) Pub. Date: May 4, 2017

(54) LATCH FOR AIR VALVE CONNECTING DEVICE

(71) Applicant: Beto Engineering & Marketing Co., Ltd., Taichung (TW)

(72) Inventor: Lo Pin WANG, Taichung (TW)

(73) Assignee: Beto Engineering & Marketing Co., Ltd., Taichung (TW)

(21) Appl. No.: 14/929,605

(22) Filed: Nov. 2, 2015

(51) Int. Cl. F16K 27/12; F16K 11/044; F16K 11/056; F16K 31/44

(52) U.S. Cl. CPC F16K 27/12; F16K 31/44; F16K 11/044; F16K 11/056; F16K 15/20

(57) ABSTRACT

An air valve connecting device includes a sliding member slidably engaged in a housing and having a pathway for aligning with a passage of the housing, and the sliding member includes a mouth for engaging with an inflation valve, a gasket is attached to the sliding member and includes a bore for engaging with the inflation valve, a latch device is slidably engaged in the housing and includes an opening for engaging with the inflation valve and for allowing the inflation valve to be engaged with the mouth of the sliding member, and the latch device is biased and forced to engage with the inflation valve with a spring biasing member for retaining the inflation valve to the housing.

### BACKGROUND OF THE INVENTION

1. Field of the Invention

The present invention relates to an air valve connecting head or device, and more particularly to an air valve connecting device including a simplified or improved structure for easily connecting to various inflation valves and having an automatic gripping structure for being easily actuated or operated with a single hand of the user and for being easily manufactured with a decreased manufacturing cost.

2. Description of the Prior Art

Typical air valve connecting devices comprise a valve housing including one end for connecting or coupling to a pressurized air reservoir and for receiving the pressurized air from the pressurized air reservoir, and a fitting port formed in the other end of the valve housing for receiving or engaging with an inflation valve and for inflating the balls, the inner tires of the bicycles or the motorcycles or the vehicles, the present inventor has developed various kinds of air valve connecting devices.

For example, U.S. Pat. No. 5,960,815 to Wang, U.S. Pat. No. 6,105,600 to Wang, U.S. Pat. No. 6,105,601 to Wang, U.S. Pat. No. 6,328,057 to Wang, U.S. Pat. No. 7,866,335 to Wang, and U.S. Pat. No. 8,539,971 to Wang disclose several of the typical air valve connecting heads for a hand-held air pump and also comprising a valve housing including one end for connecting or coupling to a pressurized air reservoir, and including a fitting port formed in an elastic annular block for engaging with an inflation valve.

However, normally, the typical air valve connecting heads required to be provided with an actuating handle or hand grip to be grasped or held or operated with one hand of the user, and the user has to use the other hand to grasp and actuate the valve housing, such that the typical air valve connecting heads comprise a structure that may not be easily operated or may not effectively grasping or holding the different inflation valves.

The present invention has arisen to mitigate and/or obviate the afore-described disadvantages of the conventional air valve connecting devices.

### SUMMARY OF THE INVENTION

The primary objective of the present invention is to provide an air valve connecting device including a simplified or improved structure for easily connecting to various inflation valves and for being easily actuated or operated with a single hand of the user and having an automatic gripping structure for being easily manufactured with a decreased manufacturing cost.

In accordance with one aspect of the invention, there is provided an air valve connecting device comprising a housing including a chamber formed therein, the housing including a first end portion and a second end portion, the housing including a passage formed therein and communicating with the chamber of the housing, and the housing including a slot formed in the first end portion and communicating with the chamber of the housing, a sliding member engaged in the chamber of the housing, the sliding member including a pathway formed therein for aligning and communicating with the passage of the housing, and the sliding member including a mouth formed therein and communicating with the pathway of the sliding member for selectively engaging with an inflation valve, a gasket attached to the sliding member and including a bore formed therein and communicating with the mouth of the sliding member for selectively engaging with the inflation valve, a latch device slidably engaged in the slot of the housing, the latch device including an opening formed therein and aligned with the bore of the gasket for selectively engaging with the inflation valve and for allowing the inflation valve to be engaged with the mouth of the sliding member, and a spring biasing member engaged with the latch device for biasing and forcing the latch device to selectively engage with the inflation valve and to lock and retain the inflation valve to the housing and to prevent the inflation valve from being disengaged from the housing.

The latch device includes a catch provided therein for selectively engaging with the inflation valve. The latch device includes a knob extended therefrom for engaging with the spring biasing member. The gasket includes a peripheral compartment formed therein and communicating with the bore of the gasket for forming a resiliently peripheral flap and for resiliently engaging with the inflation valve and for solidly and stably locking and retaining the inflation valve to the housing.

The housing includes a stop provided therein, and the latch device includes a projection extended therefrom for engaging with the stop of the housing and for limiting the latch device to move relative to the housing and for preventing the latch device from being disengaged from the housing.

The housing includes a cover secured to the first end portion of the housing, and the cover includes an orifice formed therein for engaging with the inflation valve. The sliding member includes a cap attached thereto for retaining the gasket within the sliding member, and the cap includes an engaging hole formed therein and aligned with the bore of the gasket for allowing the inflation valve to be engaged through the engaging hole of the cap and to be engaged with the mouth of the sliding member.

The sliding member includes an auxiliary pathway formed therein for selectively aligning and communicating with the passage of the housing, and the sliding member includes an auxiliary mouth formed therein and communicating with the auxiliary pathway of the sliding member for selectively engaging with an auxiliary inflation valve, an auxiliary gasket is attached to the sliding member and includes a bore formed in auxiliary gasket and communicating with the auxiliary mouth of the sliding member for selectively engaging with the auxiliary inflation valve, and an auxiliary latch device is slidably engaged in a channel of the housing, the auxiliary latch device includes an opening formed therein and aligned with the bore of the auxiliary gasket for selectively engaging with the auxiliary inflation valve and for allowing the auxiliary inflation valve to be engaged into the housing and to be engaged with the auxiliary mouth of the sliding member.

The auxiliary latch device includes a catch provided therein for selectively engaging with the auxiliary inflation valve. The housing includes a stop provided therein, and the auxiliary latch device includes a projection extended therefrom for engaging with the stop of the housing and for limiting the auxiliary latch device to move relative to the housing and for preventing the auxiliary latch device from being disengaged from the housing.

The housing includes a cover secured to the second end portion of the housing and having an orifice formed in the cover for engaging with the auxiliary inflation valve. The sliding member includes a cap attached thereto for retaining the auxiliary gasket within the sliding member, and having an engaging hole formed in the cap and aligned with the bore of the gasket for allowing the auxiliary inflation valve to be engaged with the auxiliary mouth of the sliding member.

The auxiliary gasket includes a peripheral compartment formed therein and communicating with the bore of the auxiliary gasket for forming a resiliently peripheral flap and for resiliently engaging with the auxiliary inflation valve and for solidly and stably locking and retaining the auxiliary inflation valve to the housing and for allowing the auxiliary inflation valve to be easily and quickly disengaged from the housing.

The housing includes an auxiliary spring biasing member engaged with the auxiliary latch device for biasing and forcing the auxiliary latch device to selectively engage with the auxiliary inflation valve and for locking or retaining the auxiliary inflation valve to the housing. The auxiliary latch device includes a knob extended therefrom for engaging with the auxiliary spring biasing member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of an air valve connecting device in accordance with the present invention;

FIG. 2 is a bottom perspective view of the air valve connecting device;

FIG. 3 is an upper perspective view of the air valve connecting device;

FIGS. 4, 5 are cross sectional views of the air valve connecting device, taken along lines 4-4 and 5-5 of FIG. 3 respectively;

FIGS. 6, 7, 8, 9, 10, 11, 12 are cross sectional views illustrating the operation of the air valve connecting device;

FIG. 13 is another partial exploded view illustrating the other arrangement of the air valve connecting device;

FIG. 14 is an upper perspective view of the air valve connecting device as shown in FIG. 13;

FIG. 15 is a bottom perspective view of the air valve connecting device as shown in FIG. 13;

FIG. 16 is cross sectional view of the air valve connecting device, taken along lines 16-16 of FIG. 14, illustrating the operation of the air valve connecting device as shown in FIGS. 13-15;

FIG. 17 is another cross sectional view similar to FIG. 16, illustrating the operation of the air valve connecting device as shown in FIGS. 13-16; and

FIGS. 18 and 19 are cross sectional views similar to FIGS. 16 and 17, illustrating the further arrangement of the air valve connecting device.

### DETAILED DESCRIPTION OF THE PREFERRED EMBODIMENT

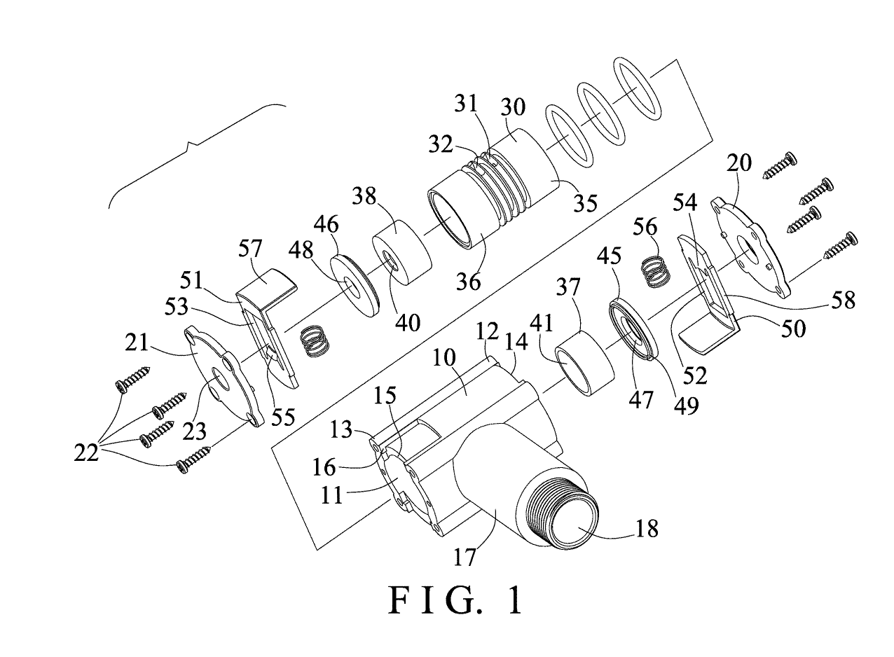

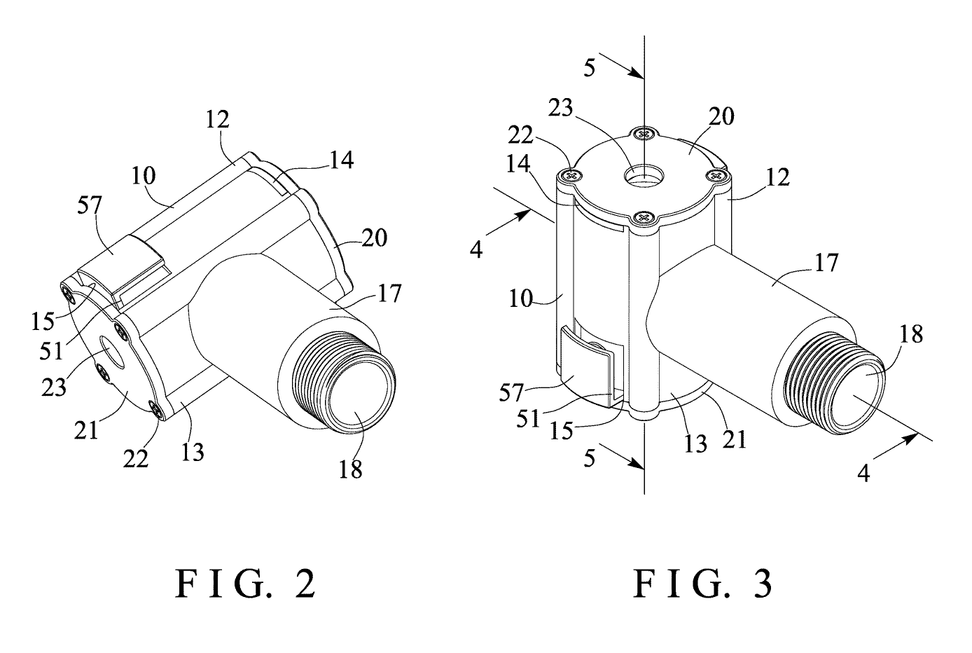

Referring to the drawings, and initially to FIGS. 1-5, an air valve connecting device in accordance with the present invention comprises a head body or housing 10 including a chamber 11 formed therein and opened through an upper or first end portion 12 and a lower or second end portion 13 of the housing 10, and including a slot 14 and a channel 15 formed in the upper or first end portion 12 and the lower or second end portion 13 of the housing 10 respectively and communicating with the chamber 11 of the housing 10, and including a key or stop 16 (FIG. 1) provided therein and extended into each of the slot 14 and the channel 15 of the housing 10, and including a cylindrical or tubular member 17 laterally extended from the housing 10 and substantially perpendicular to the housing 10, and including a bore 18 formed in the tubular member 17 for coupling to an air pump or a pressurized air reservoir (not illustrated) or the like and for receiving the pressurized air therefrom.

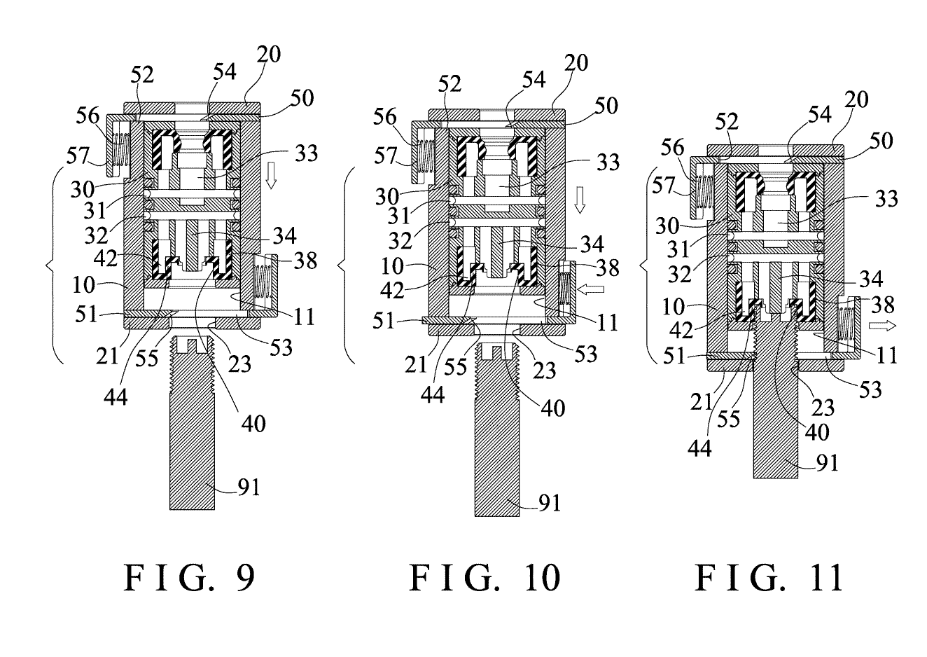

The housing 10 further includes a passage 19 formed therein and communicating with the chamber 11 of the housing 10 and the bore 18 of the tubular member 17 for allowing the pressurized air to selectively flow from the bore 18 of the tubular member 17 through the passage 19 and into the chamber 11 of the housing 10. One or more (such as two) covers 20, 21 are attached or secured to the upper or first end portion 12 and the lower or second end portion 13 of the housing 10 with latches or fasteners 22 for enclosing the chamber 11 of the housing 10, and the covers 20, 21 each include an orifice 23 formed therein for receiving or engaging with an inflation valve 90, such as the French type valve 90 (FIGS. 6-8), the U.S. type valve 91 (FIGS. 9-12), or the other inflation valve or the like, and for allowing the inflation valve 90, 91 to be engaged into the chamber 11 of the housing 10.

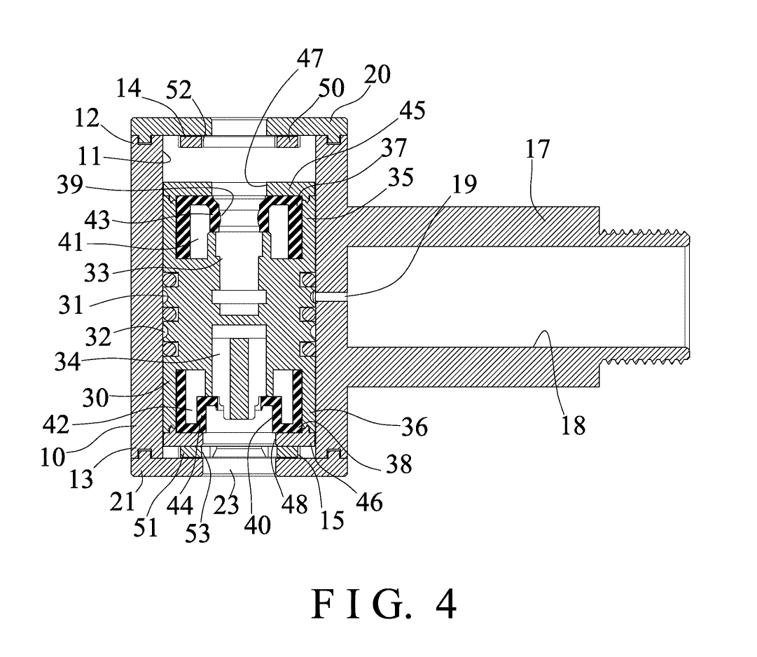

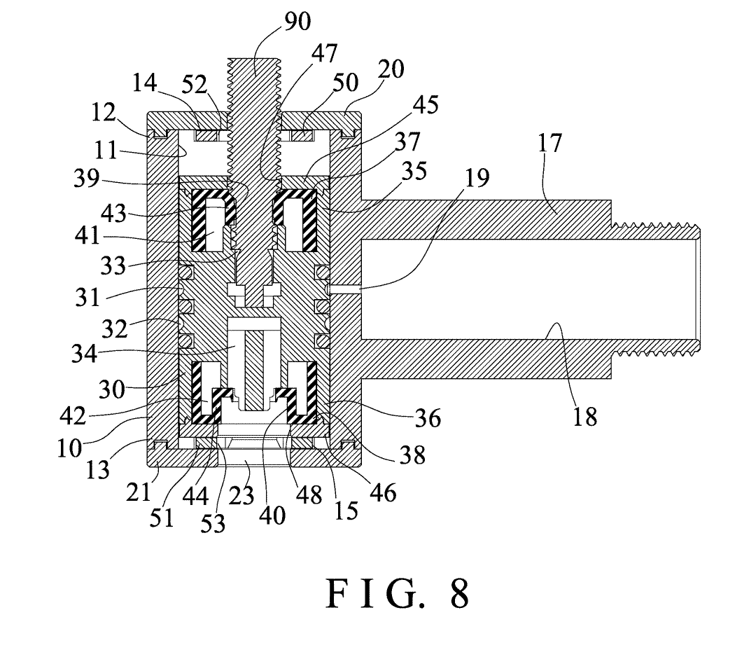

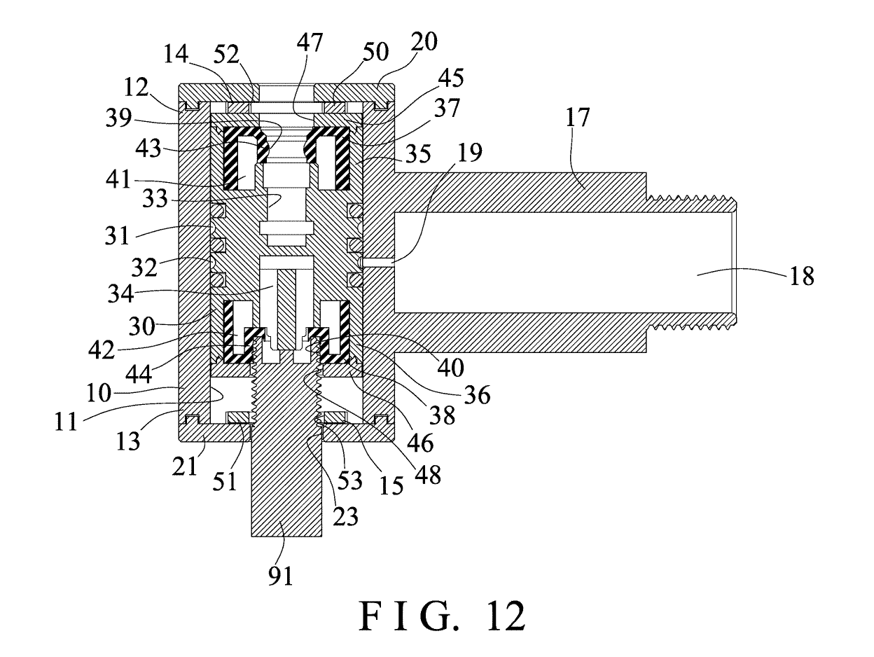

An actuating or sliding member 30 is slidably received or engaged in the chamber 11 of the housing 10 and guided or limited to slide or move within the chamber 11 of the housing 10 with or by the covers 20, 21, and includes one or more (such as two) passages or pathways 31, 32 laterally formed in the middle or intermediate portion of the sliding member 30 for selectively aligning or communicating with the passage 19 and the bore 18 of the tubular member 17, and for selectively receiving the pressurized air from the air reservoir or hand-held air pump (not illustrated) or the like. For example, as shown in FIGS. 4, 8, one of the pathways 31 of the sliding member 30 may be selectively aligned with the passage 19 of the tubular member 17, and as shown in FIG. 12, the other or auxiliary pathway 32 of the sliding member 30 may be selectively aligned with the passage 19 of the tubular member 17 when the sliding member 30 is moved relative to the housing 10.

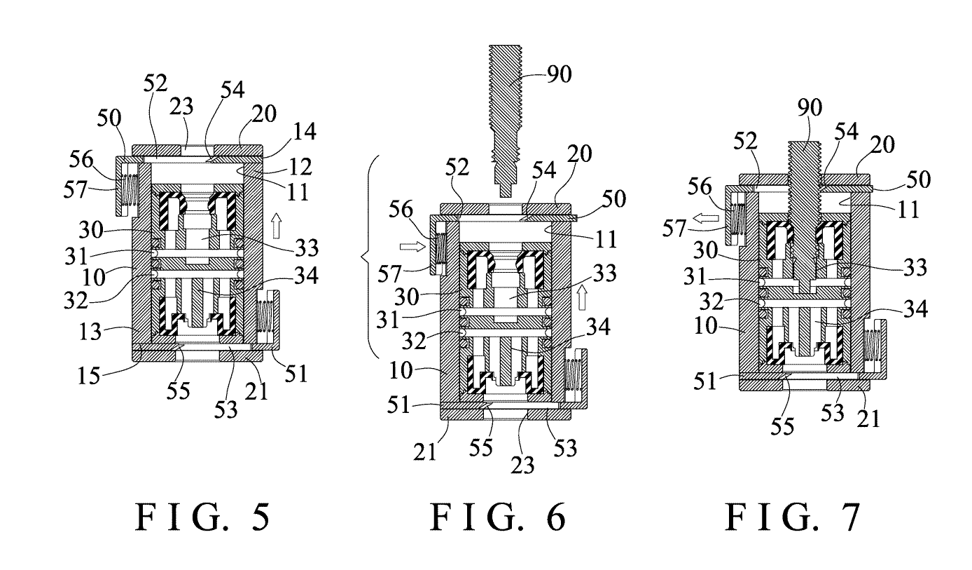

The sliding member 30 includes one or more (such as two) mouths 33, 34 formed therein, such as formed in the upper or first end portion 35 and the lower or second end portion 36 of the sliding member 30 respectively. As best shown in FIGS. 5-7 and 9-11, the mouths 33, 34 of the sliding member 30 are communicating with the pathways 31, 32 of the sliding member 30 respectively for allowing the pressurized air to selectively flow from the pathways 31, 32 into the mouths 33, 34 of the sliding member 30 respectively and then to flow out of the sliding member 30 selectively. The mouths 33, 34 are formed or opened through the upper or first end portion 35 and the lower or bottom portion 36 of the sliding member 30 respectively for receiving or engaging with different inflation valves 90, 91, such as the French type valves 90 (FIGS. 6-8), the U.S. type valves 91 (FIGS. 9-12), or the other inflation valves or the like.

One or more (such as two) cylindrical gaskets 37, 38 are engaged into the chamber 11 of the housing 10 and attached onto the sliding member 30 and engaged with the mouths 33, 34 of the sliding member 30 respectively and moved in concert with the sliding member 30, and the gaskets 37, 38 each include a bore 39, 40 formed therein (FIG. 4) and communicating with the mouth 33, 34 of the sliding member 30 respectively for selectively receiving or engaging with the inflation valve 90, 91 and for allowing the inflation valve 90, 91 to be engaged with the mouth 33, 34 of the sliding member 30. The gaskets 37, 38 are made of soft or resilient materials, such as rubber, plastic, composite materials, or other synthetic materials for softly or resiliently clamping or grasping or engaging with the inflation valve 90, 91, and for sealably engaging with the inflation valve 90, 91.

The gaskets 37, 38 each include a peripheral compartment 41, 42 formed therein and communicating with the bore 39, 40 thereof for forming or defining a resiliently peripheral flap 43, 44 which may thus be formed or defined between the bore 39, 40 and the peripheral compartment 41, 42 of the gasket 37, 38 and which may softly or resiliently clamp or grasp or engage with the inflation valve 90, 91 and for sealably engaging with the inflation valve 90, 91. It is to be noted that the pressurized air from the mouth 33, 34 of the sliding member 30 may selectively flow into the peripheral compartment 41, 42 of the gasket 37, 38 and may force the peripheral flap 43, 44 to resiliently and sealably clamp or grasp or engage with the inflation valve 90, 91.

One or more (such as two) shields or caps 45, 46 are attached or secured to the upper or first end portion 35 and the lower or second end portion 36 of the sliding member 30 with latches or fasteners or a threading engagement 49 (FIG. 1) for anchoring or retaining the gasket 37, 38 within the sliding member 30. The caps 45, 46 each include an engaging hole 47, 48 formed therein and aligned or communicating with the bore 39, 40 of the gasket 37, 38 for allowing the inflation valve 90, 91 to be engaged with the bore 39, 40 of the gasket 37, 38 and to be selectively engaged with the mouth 33, 34 of the sliding member 30 and thus for allowing the pressurized air to be selectively supplied to the inflation valve 90, 91 (FIGS. 6-12).

One or more (such as two) latch devices 50, 51 are slidably received or engaged in the slot 14 and the channel 15 of the housing 10 respectively, and each include a space or opening 52, 53 formed therein and aligned or communicating with the engaging hole 47, 48 of the cap 45, 46 and the orifice 23 of the cover 20, 21 for selectively receiving or engaging with the inflation valve 90, 91 and for allowing the inflation valve 90, 91 to be engaged through the bore 39, 40 of the gasket 37, 38 and to be engaged with the mouth 33, 34 of the sliding member 30. It is preferable that the latch devices 50, 51 each include a pawl or catch 54, 55 formed or provided therein (FIG. 1) for selectively engaging with the inflation valve 90, 91 and for solidly and stably anchoring or retaining or positioning or locking the inflation valve 90, 91 to the housing 10.

A spring biasing member 56 may further be provided and disposed or engaged between the housing 10 and the latch device 50, 51 for biasing and forcing the catch 54, 55 of the latch device 50, 51 to selectively engage with the inflation valve 90, 91, for example, the latch devices 50, 51 each include an ear or flap or hand grip or knob 57 extended therefrom for engaging with the spring biasing member 56 and for allowing the latch devices 50, 51 to be biased and moved relative to the housing 10. It is preferable that the latch devices 50, 51 each include a projection 58 extended therefrom (FIG. 1) for engaging with the stop 16 of the housing 10 and for limiting the latch device 50, 51 to slide or move relative to the housing 10 and for preventing the latch device 50, 51 from being disengaged or separated from the housing 10.

In operation, as shown in FIGS. 6-8, the inflation valve 90 may be engaged into the orifice 23 of the cover 20 and the opening 52 of the latch device 50 and the engaging hole 47 of the cap 45, and the bore 39 of the gasket 37 and may then be engaged with the mouth 33 of the sliding member 30 and thus for allowing the pressurized air to be selectively filled and supplied to the inflation valve 90. As shown in FIG. 6, the knob 57 of the latch device 50 may be depressed or forced onto or against the spring biasing member 56 and may be moved relative to the housing 10 for allowing the inflation valve 90 to be easily and quickly engaged into the opening 52 of the latch device 50 and to be easily and quickly engaged with the mouth 33 of the sliding member 30, and the catch 54 of the latch device 50 may then be biased and forced to engage with the inflation valve 90 by the spring biasing member 56 when the knob 57 of the latch device 50 is released.

In addition, the pressurized air supplied from the mouth 33, 34 of the sliding member 30 may also flow into the peripheral compartment 41, 42 of the gasket 37, 38 and may force the peripheral flap 43, 44 to resiliently and sealably clamp or grasp or engage with the inflation valve 90, 91. Similarly, as shown in FIGS. 9-12, the other inflation valve 91 or the like may be engaged into the orifice 23 of the cover 21 and the opening 53 of the auxiliary latch device 51 and the engaging hole 48 of the cap 46, and the bore 40 of the auxiliary gasket 38 and may then be engaged with the auxiliary mouth 34 of the sliding member 30 and thus for allowing the pressurized air to be selectively supplied to the auxiliary inflation valve 91. The inflation valve 91 may also be directly moved or engaged through the opening 53 of the auxiliary latch device 51 and moved through the catch 55 of the auxiliary latch device 51 without depressing the knob 57 of the latch device 50 onto or against the spring biasing member 56. One of the spring biasing members 56 or the auxiliary spring biasing member 56 may also bias and force the catch 55 of the auxiliary latch device 51 to selectively engage with the auxiliary inflation valve 91.

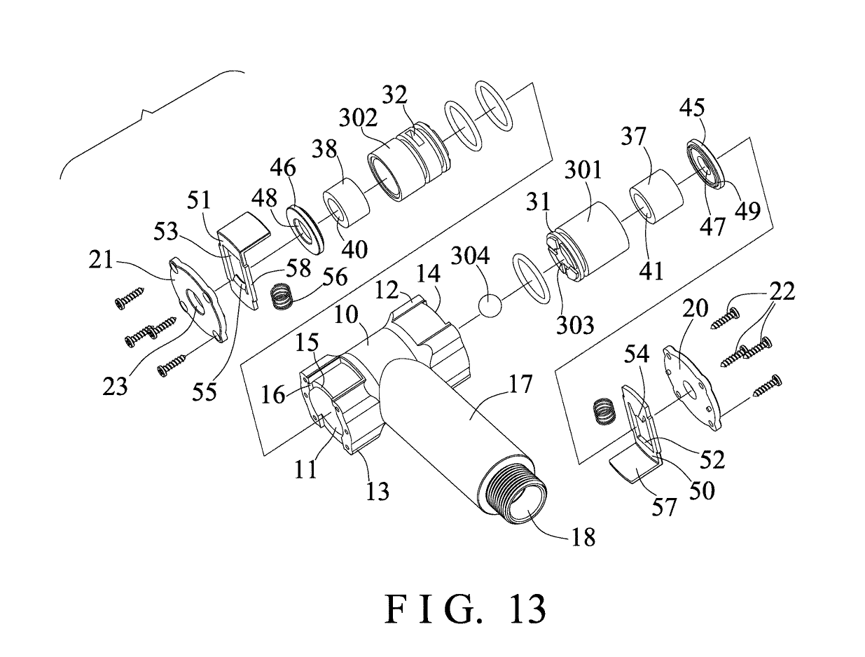

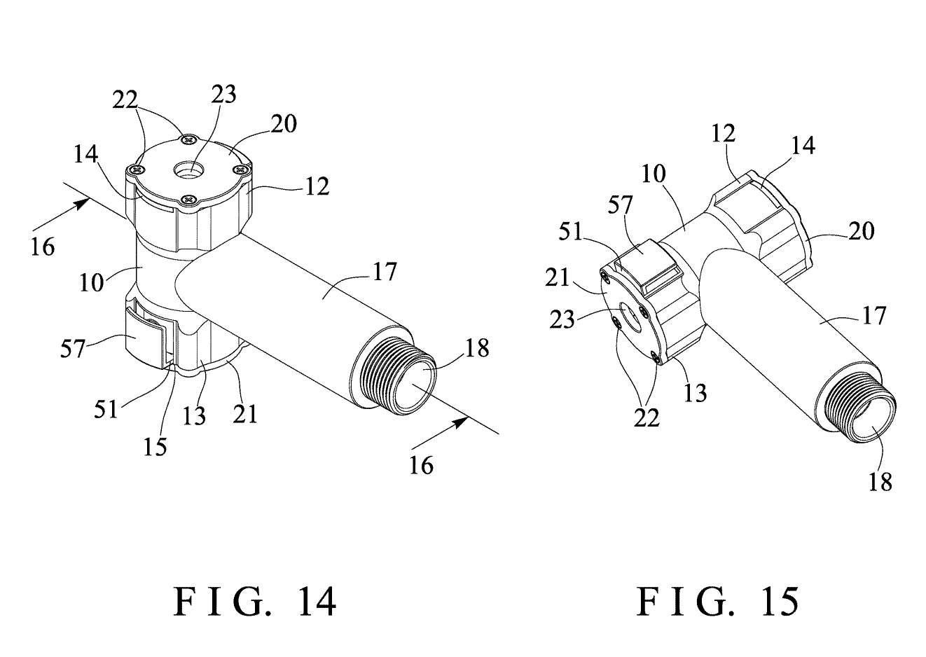

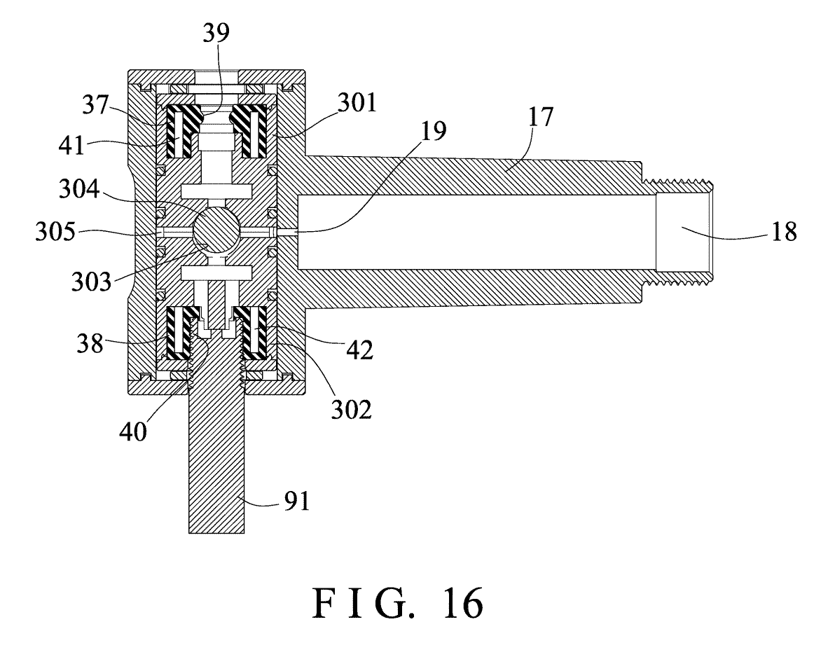

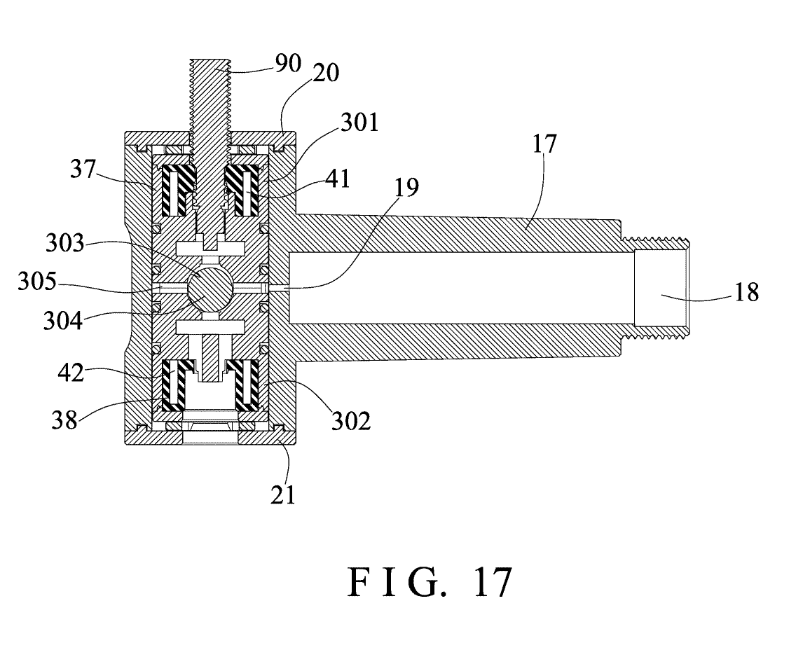

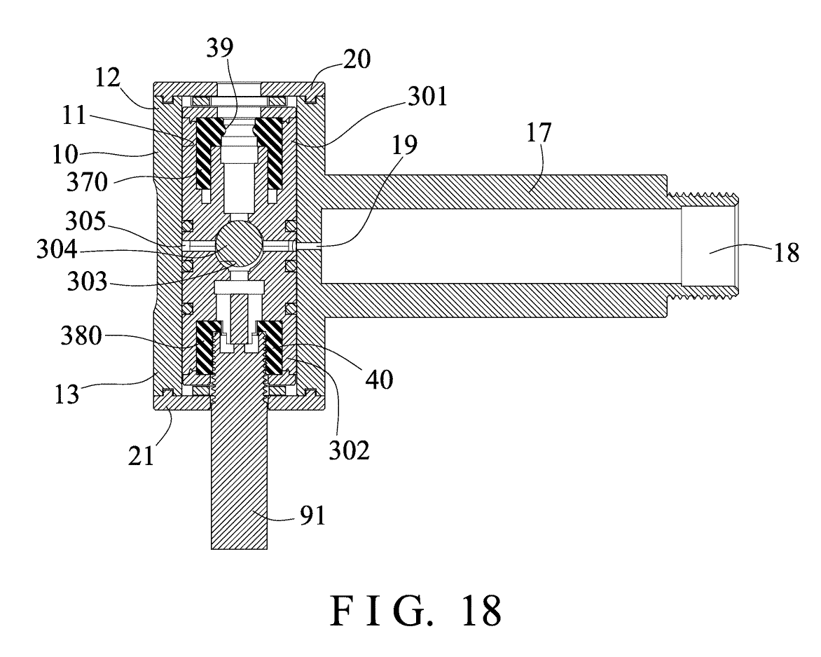

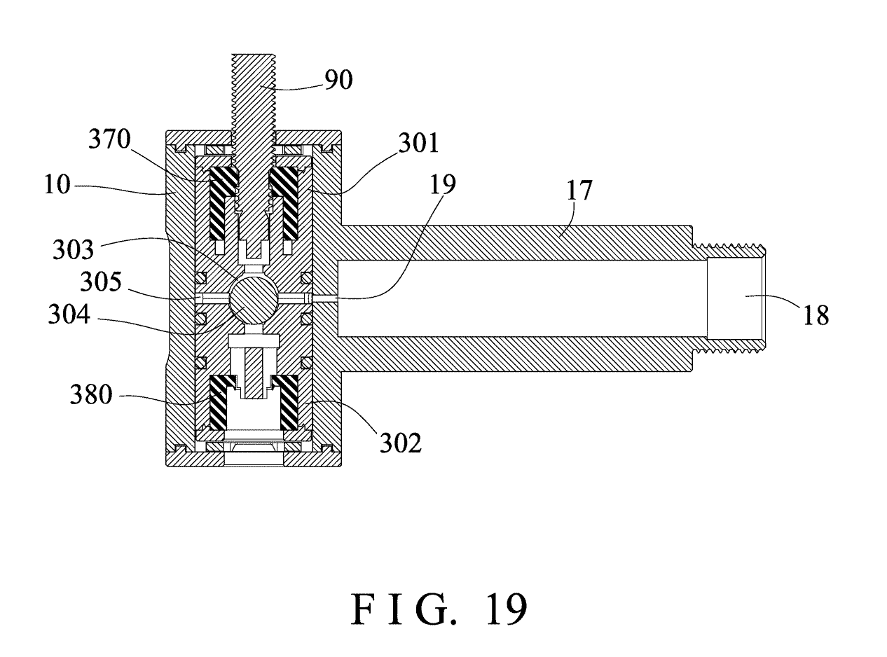

Alternatively, as shown in FIGS. 13-19, the single sliding member 30 as shown in FIGS. 1-12 may be replaced with two sliding elements 301, 302 each of which may include a curved or semi-spherical recess 303 formed therein, and the recesses 303 of the sliding elements 301, 302 are faced or directed toward each other for receiving or engaging with a spherical separator or separating member 304 which may suitably space or separate the sliding elements 301, 302 away from each other for forming or defining a spacing gap 305 (FIGS. 16-19) between the sliding elements 301, 302, in which the gap 305 is aligned or communicated with the passage 19 and the bore 18 of the tubular member 17 for allowing the pressurized air to be supplied into the mouth 33, 34 of the sliding elements 301, 302. Further alternatively, as shown in FIGS. 18-19, the gaskets 370, 380 may have no peripheral compartment formed therein.

Accordingly, the air valve connecting device in accordance with the present invention includes a simplified structure for easily connecting to various inflation valves and for being easily actuated or operated with a single hand of the user and having an automatic gripping structure or latch device for being easily manufactured with a decreased manufacturing cost.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An air valve connecting device comprising:
a housing including a chamber formed therein, said housing including a first end portion and a second end portion, said housing including a passage formed therein and communicating with said chamber of said housing, and said housing including a slot formed in said first end portion and communicating with said chamber of said housing,
a sliding member engaged in said chamber of said housing, said sliding member including a pathway formed therein for aligning and communicating with said passage of said housing, and said sliding member including a mouth formed therein and communicating with said pathway of said sliding member for selectively engaging with an inflation valve,
a gasket attached to said sliding member and including a bore formed therein and communicating with said mouth of said sliding member for selectively engaging with said inflation valve,
a latch device slidably engaged in said slot of said housing, said latch device including an opening formed therein and aligned with said bore of said gasket for selectively engaging with said inflation valve and for allowing said inflation valve to be engaged with said mouth of said sliding member, and
a spring biasing member engaged with said latch device for biasing and forcing said latch device to selectively engage with said inflation valve.

2. The air valve connecting device as claimed in claim 1, wherein said latch device includes a catch provided therein for selectively engaging with said inflation valve.

3. The air valve connecting device as claimed in claim 1, wherein said latch device includes a knob extended therefrom for engaging with said spring biasing member.

4. The air valve connecting device as claimed in claim 1, wherein said housing includes a stop provided therein, and said latch device includes a projection extended therefrom for engaging with said stop of said housing and for limiting said latch device to move relative to said housing and for preventing said latch device from being disengaged from said housing.

5. The air valve connecting device as claimed in claim 1, wherein said housing includes a cover secured to said first end portion of said housing, and said cover includes an orifice formed therein for engaging with said inflation valve.

6. The air valve connecting device as claimed in claim 1, wherein said sliding member includes a cap attached thereto for retaining said gasket within said sliding member, and said cap includes an engaging hole formed therein and aligned with said bore of said gasket for allowing said inflation valve to be engaged with said mouth of said sliding member.

7. The air valve connecting device as claimed in claim 1, wherein said gasket includes a peripheral compartment formed therein and communicating with said bore of said gasket for forming a resiliently peripheral flap and for resiliently engaging with said inflation valve.

8. The air valve connecting device as claimed in claim 1, wherein said sliding member includes an auxiliary pathway formed therein for selectively aligning and communicating with said passage of said housing, and said sliding member includes an auxiliary mouth formed therein and communicating with said auxiliary pathway of said sliding member for selectively engaging with an auxiliary inflation valve, an auxiliary gasket is attached to said sliding member and includes a bore formed in auxiliary gasket and communicating with said auxiliary mouth of said sliding member for selectively engaging with said auxiliary inflation valve, and an auxiliary latch device is slidably engaged in a channel of said housing, said auxiliary latch device includes an opening formed therein and aligned with said bore of said auxiliary gasket for selectively engaging with said auxiliary inflation valve and for allowing said auxiliary inflation valve to be engaged with said auxiliary mouth of said sliding member.

9. The air valve connecting device as claimed in claim 8, wherein said auxiliary latch device includes a catch provided therein for selectively engaging with said auxiliary inflation valve.

10. The air valve connecting device as claimed in claim 8, wherein said housing includes a stop provided therein, and said auxiliary latch device includes a projection extended therefrom for engaging with said stop of said housing and for limiting said auxiliary latch device to move relative to said housing and for preventing said auxiliary latch device from being disengaged from said housing.

11. The air valve connecting device as claimed in claim 8, wherein said housing includes a cover secured to said second end portion of said housing and having an orifice formed in said cover for engaging with said auxiliary inflation valve.

12. The air valve connecting device as claimed in claim 8, wherein said sliding member includes a cap attached thereto for retaining said auxiliary gasket within said sliding member, and having an engaging hole formed in said cap and aligned with said bore of said gasket for allowing said auxiliary inflation valve to be engaged with said auxiliary mouth of said sliding member.

13. The air valve connecting device as claimed in claim 8, wherein said auxiliary gasket includes a peripheral compartment formed therein and communicating with said bore of said auxiliary gasket for forming a resiliently peripheral flap and for resiliently engaging with said auxiliary inflation valve.

14. The air valve connecting device as claimed in claim 8, wherein said housing includes an auxiliary spring biasing member engaged with said auxiliary latch device for biasing and forcing said auxiliary latch device to selectively engage with said auxiliary inflation valve.

15. The air valve connecting device as claimed in claim 14, wherein said auxiliary latch device includes a knob extended therefrom for engaging with said auxiliary spring biasing member.
